(19) United States
(12) Patent Application Publication
(10) Pub. No.: US 2017/0206785 A1
(43) Pub. Date: Jul. 20, 2017

(54) VISION SENSING SYSTEM FOR SMART PARKING

(71) Applicant: SeeVider, Inc., Campbell, CA (US)

(72) Inventors: Hobin Kim, Campbell, CA (US); Kilyrong Han, Seongnam-si (KR)

(21) Appl. No.: 14/997,431

(22) Filed: Jan. 15, 2016

(51) Int. Cl. G08G 1/14; G08G 1/16

(52) U.S. Cl. CPC G08G 1/142; G08G 1/146; G08G 1/168; G08G 1/149

(57) ABSTRACT

A smart parking system comprises a plurality of dimmable lighting fixtures for illuminating a parking garage having parking spaces and aisles. The system also includes a plurality of occupancy indicator lights to emit light indicative of occupancy status of the parking spaces. The system also includes a plurality of vision sensing units, each vision sensing unit coupled to a respective dimmable lighting fixture and a respective occupancy indicator light. Each vision sensor includes a camera to capture images of a respective plurality of the parking spaces and a respective aisle of the parking garage and processes the images to control the respective occupancy indicator light and respective dimmable lighting fixture.

### CROSS REFERENCE TO RELATED APPLICATIONS

The present application claims priority from Provisional Patent Application No. 62/105,690 filed on Jan. 20, 2015, which is incorporated herein by reference in their entirety.

### FIELD OF THE DISCLOSURE

This disclosure pertains in general to smart parking systems.

### DESCRIPTION OF THE RELATED ART

Parking garages are ubiquitous throughout any city. However, existing parking garages are inefficiently designed for several reasons. First, artificial lighting consumes a significant part of energy (>90%) consumed by the parking garage due to lighting of areas where there are no persons or vehicles. Second, it can be difficult to locate a parking spot in the garage due to lack of information about available spaces, thereby leading drivers to consume extra gas and time in locating a space. Third, security is often a problem in parking garages due to their easy accessibility.

### SUMMARY OF THE INVENTION

Embodiments of the present disclosure relate to a smart parking system. The system comprises a plurality of dimmable lighting fixtures for illuminating a parking garage having parking spaces and aisles. The system also includes a plurality of occupancy indicator lights to emit light indicative of occupancy status of the parking spaces. The system also includes a plurality of vision sensing units, each vision sensing unit coupled to a respective dimmable lighting fixture and a respective occupancy indicator light. Each vision sensor includes a camera to capture images of a respective plurality of the parking spaces and a respective aisle of the parking garage. Each vision sensor includes an occupancy detection module to determine occupancy status of the respective plurality of parking spaces from the captured images. Each vision sensor includes an occupancy indicator control module to generate an occupancy indicator setting for the light emitted by the respective occupancy indicator light based on the occupancy status. Each vision sensor also includes a motion detection module to detect motion in the parking garage from the captured images. Each vision sensor further includes a brightness control module to generate a brightness setting for a brightness of the respective dimmable light fixture based on the detected motion.

### BRIEF DESCRIPTION OF THE DRAWINGS

The teachings of the embodiments disclosed herein can be readily understood by considering the following detailed description in conjunction with the accompanying drawings.

FIG. 1 is a smart parking system with vision sensor units.

FIG. 2 is a perspective view of a parking garage with vision sensor units.

FIG. 3 is a detailed view of a vision sensor unit and a dimmable light fixture.

FIG. 4 is a flowchart for generating an occupancy indicator setting.

FIG. 5 is a diagram of a dimming profile of the light fixture, according to an embodiment.

FIG. 6 is a flowchart for a method of smart lighting and smart parking performed in a vision sensor unit.

FIG. 7 is an overhead view of a parking garage with vision sensor units.

FIG. 8 is a side view of a parking garage with vision sensor units divided into lighting groups.

FIG. 9 illustrates the hardware architecture of a client device or server.

### DETAILED DESCRIPTION

Reference will now be made in detail to several embodiments, examples of which are illustrated in the accompanying figures. It is noted that wherever practicable similar or like reference numbers may be used in the figures and may indicate similar or like functionality. The figures and accompanying description depict various embodiments for purposes of illustration only. One skilled in the art will readily recognize from the following description that alternative embodiments of the structures and methods illustrated herein may be employed without departing from the principles described herein.

Embodiments of the present disclosure include a smart parking system with vision sensing units. A parking garage includes dimmable lighting fixtures and occupancy indicator lights emitting light indicative of whether parking spaces are occupied. Vision sensing units are coupled to the dimmable lighting fixture and occupancy lights. Each vision sensing units include a camera that is oriented in a direction that allows it to capturing images of parking spaces and aisles of the parking garage. A single vision sensing unit can serve multiple functions. For example, the vision sensing unit can process the images to both detect motion in the garage and occupancy of the parking spaces. Detected motion is used to control dimming of the lighting fixtures, and the space occupancy status is used to control the occupancy indicator lights (e.g. to show occupied/non-occupied space). Using the vision sensor, existing and future parking garages can easily be retrofitted with the capabilities of a smart parking system.

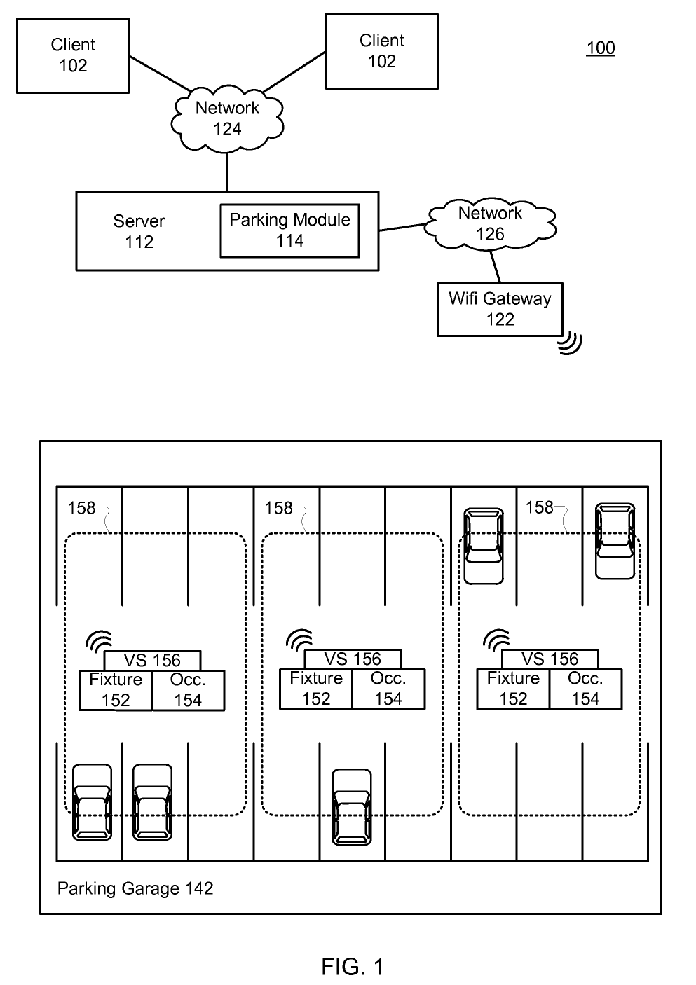

FIG. 1 is a smart parking system 100 with vision sensor units 156, according to an embodiment. The smart parking system 100 includes two client devices 102, a parking server 112, a WiFi gateway 122, and a parking garage 142. The clients 102 are in communication with the server 112 through a network 124. The server is in communication with the WiFi gateway 122 through a network 126.

The parking garage 142 includes two rows of parking spaces and an aisle representing the driving pathways between the parking spaces. The parking garage 142 may include greater numbers of parking spaces and aisles, as well as multiple levels. The parking garage 142 also includes multiple lighting fixtures 152, multiple occupancy indicator lights 154, and multiple vision sensor units 156.

Light fixtures 152 provide light illumination for vehicles and persons in the parking garage 142. Light fixtures 152 are overhead fixtures attached to a ceiling of the parking garage and are located over the center of the aisle. In some embodiments, the light fixtures 152 may be wall mounted fixtures. The light fixtures 152 can be, for example, dimmable light emitting diode (LED) fixtures, dimmable fluorescent fixtures, or any other type of dimmable lighting source that emits sufficient light at maximum brightness to illuminate the parking garage but can be dimmed to reduce its power consumption.

Several occupancy indicator lights 154 are also attached to the ceiling of the parking garage. The occupancy indicator lights 154 can be multicolor LEDs (RGB). The color or pattern of the light emitted by the occupancy indicator lights 154 can be varied depending on the occupancy and reservation status of the parking spaces in proximity to the occupancy indicator lights 154. For example, if all parking spaces near an occupancy indicator light 154 are occupied, the light 154 may be red. If there is at least one open parking space near the occupancy indicator light 154, the occupancy indicator light 154 may be green.

Vision sensors units 156 are located throughout the parking garage 142 and each light fixture 152 and occupancy indicator light 154 is coupled to its own vision sensor unit 156. Each vision sensor unit 156 includes a camera oriented to have a field of view 158 capable of capturing images of several parking spaces (e.g. 6 spaces) and the aisle of the parking garage. The vision sensor unit 156 can process the images to detect motion due to vehicles or persons moving along the aisle, and control the dimmable brightness level of the light fixture 152 depending on whether there is detected motion.

The vision sensor unit 156 can also process the images to detect whether the parking spaces are occupied, and control the light color or pattern emitted by the occupancy indicator light 154 depending on whether the spaces are occupied.

Vision sensors 156 also communicate wirelessly with WiFi gateway 122, which in turn communicates with server 112 through network 126. Server 112 includes a parking module 114 that provides parking services to the client devices 102. In one embodiment, parking module 114 can receive information from the vision sensors 156 about the occupancy status of the parking spaces. The parking module 114 can then provide this occupancy status information to the client devices 102 or provide guidance to the client devices 102 about how to reach the open parking spaces. The parking module 114 may also receive reservations from the client devices 102 for open parking spaces. The reservation information is transmitted to the vision sensors 156, which in turn use the reservation information to control the light emitted by the occupancy indicator lights 154.

The parking module 156 can also maintain a map of the parking garage 142, the locations of the vision sensors 156 in the parking garage 142, and information about which parking spaces monitored by which vision sensors 156. Each vision sensor unit 156 and parking space may be assigned a unique address by the parking module 114, which is used by the parking module 114 to communicate with the vision sensors 156.

The vision sensor units 156 operate in conjunction with the server 112 to provide both parking guidance as well as light control, providing an easy to install and low cost solution for increasing parking garage efficiency. The vision sensor units 156 can be connected to existing light fixtures 152 without need for re-wiring of garages electricity. The vision sensor units 156 can also perform local processing for images to reduce the communication with the server 112. The vision sensor units 156 may also send the images to the server 112 for security purposes. The server 112 can further provide real time parking services to the client devices 102 by leveraging the functions of the vision sensor units 156.

In one embodiment, the network 124 or 126 can be an internal network or the Internet. Network 124 and 126 may be the same network, or separate networks. In one embodiment, the network 124 or 126 uses standard communications technologies and/or protocols. Thus, the network 124 or 126 can include links using technologies such as Ethernet, 802.11, integrated services digital network (ISDN), digital subscriber line (DSL), asynchronous transfer mode (ATM), etc. Similarly, the networking protocols used on the network 124 or 126 can include the transmission control protocol/Internet protocol (TCP/IP), the hypertext transport protocol (HTTP), the simple mail transfer protocol (SMTP), the file transfer protocol (FTP), etc. The data exchanged over the network 124 or 126 can be represented using technologies and/or formats including the hypertext markup language (HTML), the extensible markup language (XML), etc. In addition, all or some of the links can be encrypted using conventional encryption technologies such as the secure sockets layer (SSL), Secure HTTP and/or virtual private networks (VPNs). In another embodiment, the entities can use custom and/or dedicated data communications technologies instead of, or in addition to, the ones described above.

In one embodiment, a client device 110 is a computing device, such as a desktop computer, laptop computer, tablet computer, smartphone, etc. The client device 110 executes a web browser, such as CHROME or SAFARI, or a dedicated parking software program (e.g. an application) that displays parking guidance to a user or allows a user to make reservations for opening parking spaces.

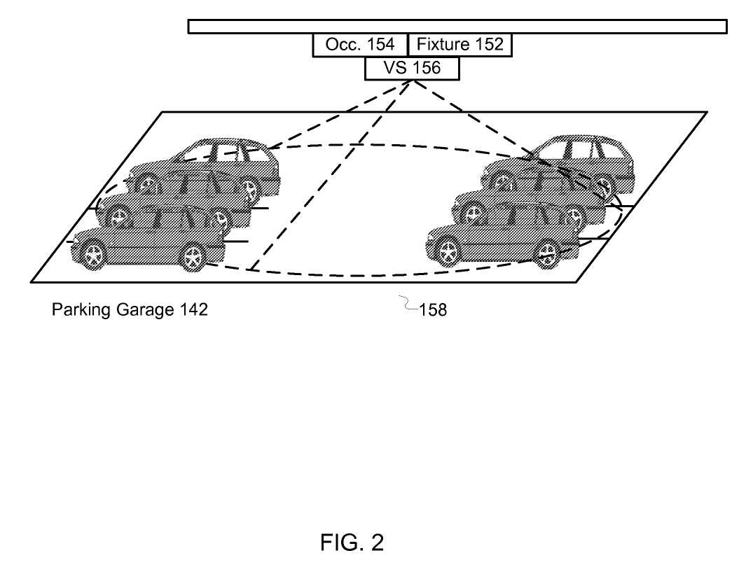

FIG. 2 is a perspective view of a parking garage 142 with vision sensor units 156, according to an embodiment. The lighting fixture 152, occupancy indicator light 154 and vision sensor 156 are all attached to a ceiling of the parking garage 142. The lighting fixture 152 may be a pre-existing light fixture 152 that already exists in a parking garage. The vision sensor 156 is connected to and powered from the same AC power line that provides power to the light fixture 152 such that no re-wiring of AC power is needed. The vision sensor 156 has a field of view that is sufficient to capture images of six parking spaces as well the aisle between the parking spaces.

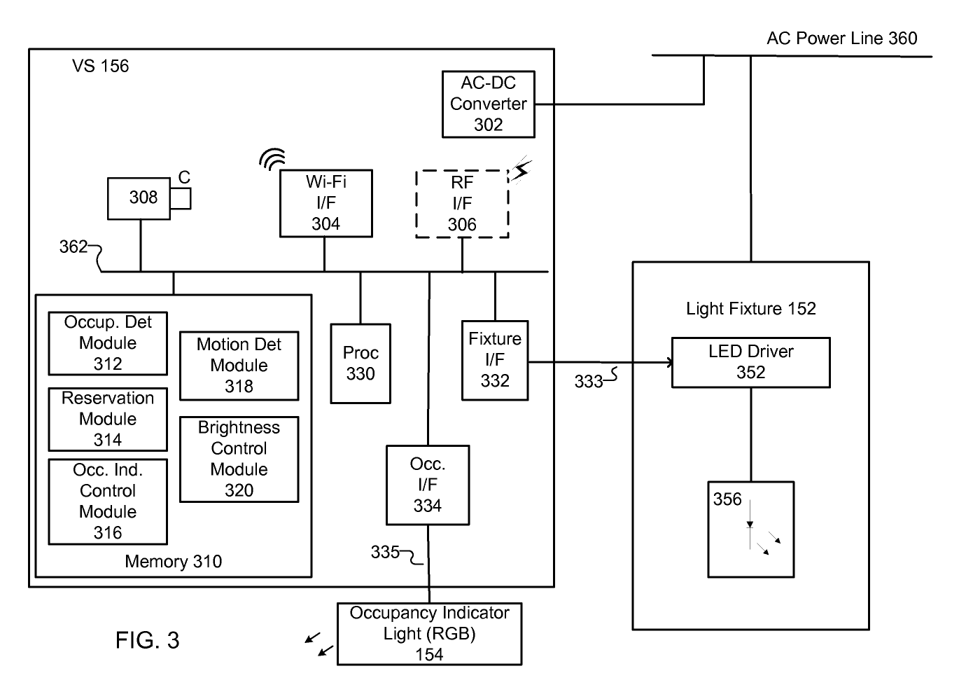

FIG. 3 is a detailed view of a vision sensor unit 156 and a dimmable light fixture 152, according to an embodiment. The vision sensor unit 156 and light fixture 152 are both connected to and powered from a common AC power line 360. The vision sensor unit 156 includes an AC-DC converter 302. AC-DC converter 302 converts the AC voltage from the AC power line 360 into one or more DC voltages (e.g. 12V) that are suitable for powering the components inside the vision sensor unit 156.

The vision sensor unit 156 also includes a WiFi interface 304, a radio frequency interface 306, a camera 308, a memory 310, a processor 330, an occupancy indicator interface 334, and a lighting fixture interface 332 communicating over a communication bus 362. In one embodiment, the components of the vision sensor unit 156 can be comprised of separate hardware circuits. In another embodiment, some of the components may be combined into a single SoC (system on chip). Additionally, the components of the vision sensor unit 156 may be separated amongst several physical housings that are connected through cables, or the components of the vision sensor 156 may all be in the same physical housing. Further, in some embodiments the vision sensor unit 156, indicator light 154, and light fixture 152 may be combined into a single integrated device.

Camera 308 captures images of the parking spaces and aisle. The camera 308 may capture a continuous a video stream of images (e.g. at 30 frames per second) or may periodically capture images (e.g. every 1 second). The camera 308 may have a CMOS sensor and a wide angle lens to capture a wide field of view. The camera 308 may also have night-vision capabilities such that it can capture images in low light situations.

The Wi-Fi interface 304 receives wireless signals that include reservation information about particular parking spots that have been reserved. The Wi-Fi interface 304 also transmits wireless signals that include occupancy information about particular parking spots that are currently occupied. Wi-Fi interface 304 is an example of one type of wireless interface, and in other embodiments other wireless interfaces can be used to transmit and receive wireless signals, such as 3G or Long Term Evolution (LTE) interfaces.

Memory 310 is a non-transitory computer readable medium that can store data. Examples of memory 310 into hard disk drives, solid state drives, flash drives, random access memory, etc. Memory 310 stores an occupancy detection module 312, reservation module 314, indicator control module 316, motion detection module 318, and a brightness control module 320. Each module includes software instructions that can be executed by the processor 330 for performing the functions of the modules described herein. In other embodiments, the modules may be implemented as hardware circuits or a combination of software and hardware. Memory 310 may also store an operation system, such as the ANDROID operating system.

Occupancy detection module 312 processes the images detected by the camera 308 to determine the occupancy status of each parking spaces in the images. The occupancy detection module 312 may only process a region of interest (ROI) in the image that includes the parking spaces but does not include the remainder of the image (e.g. the aisles). The ROI may be set different for each vision sensor unit 156, depending on the location of the parking spaces in the images captured by the vision sensor unit 156.

The occupancy detection module 312 applies one of or a combination of several different occupancy detection algorithms to the region of interest to determine if the spaces in the region of interest are occupied. In one embodiment, the occupancy detection module 312 converts the images to grayscale images. A Gaussian filter is applied to the image. An edge detection algorithm is applied to the filtered image to detect edges in the region of interest. The algorithm calculates a number which represents how many edges are detected in the region of interest. The edges are compared to an edge threshold. If the edges are higher than the edge threshold, it is determined that a space is occupied. If the edges are lower than the edge threshold, it is determined that a space is unoccupied. The edge threshold may be found and set to its proper value through a training process where the same algorithm is executed under a real environment with occupied spaces and unoccupied spaces.

Many regions of interest (ROI) can be defined in the image so that each ROI covers each parking space in the image. Every time an image from camera 308 is captured, the occupancy detection module 312 processes the occupancy detection algorithm for each ROI in sequence. Consequently, the amount of detected edges is calculated for each ROI. Each ROI also has its own edge threshold depending on the installation of the vision sensor. For many parking spaces in an image, the occupancy detection module can determine whether each space is occupied or not by comparing the calculated edge quantity to the corresponding edge threshold, respectively. Furthermore, the occupancy detection module 312 can set main parameters of the algorithm respectively for each ROI.

In other embodiments, other algorithms may be used to detect the occupancy status of the parking spaces. Examples of such algorithms include a color difference algorithm or a pattern recognition algorithm. In the case of a color difference algorithm, the occupancy detection module 312 saves a background image when a parking space is not occupied. Various color information based RGB or HSV color models can be calculated from the background image. For example, the average of Red value of the RGB model for every pixel in a given image can be a specific color information. A color information changes as the parking space is occupied by a vehicle with different color from the parking space. Every time an image from camera 308 is captured, the occupancy detection module calculates color information in the same way. If the difference between the calculated value and that of the background image is more than a reference value, it is determined that the space is occupied.

In the case of a pattern recognition algorithm, the occupancy detection module 312 tries to find a specific pattern in a given image. A rectangular shape of license plate with a specific size can be a good pattern to determine if a parking space is occupied by a vehicle. Usually the occupancy detection module 312 has a reference pattern which consists of edges. Every time an image from the camera 308 is captured, the occupancy detection module 312 executes some general image processing to detect major edges in the image. Then, it tries to match the reference pattern to a candidate pattern in the image which consists of detected edges and is similar to the reference pattern in shape and size. If the reference and candidate patterns have a high degree of similarity, the occupancy detection module 312 determines that the reference pattern of the license plate is found and the space is occupied by a vehicle.

In some embodiments, occupancy detection module 312 processes the images detected by the camera 308 to detect license plate numbers of parked vehicles in the image. License plate numbers can be detected, for example, by performing optical character recognition (OCR) to extract text from the camera images. License plate numbers may also be detected using a machine learned model that is trained from many training plates.

The reservation module 314 maintains reservation information about which parking spaces are reserved 314. The reservation information may be received, for example, from the server 112. The reservation information may include a unique identifier for each parking space monitored by the camera 308, reservation status about whether the space is reserved or not, license plates for cars that have reserved the spaces, and start and end times for the reservations.

The occupancy indicator control module 316 generates an occupancy indicator setting for the occupancy indicator light 154. The occupancy indicator setting indicates how light (e.g., light color or light pattern) should be emitted by the occupancy indicator light 154. The occupancy indicator setting depends on factors such as whether there are any unoccupied parking spaces, whether the parking spaces are reserved, and whether any vehicle has exceeded its reserved time limit.

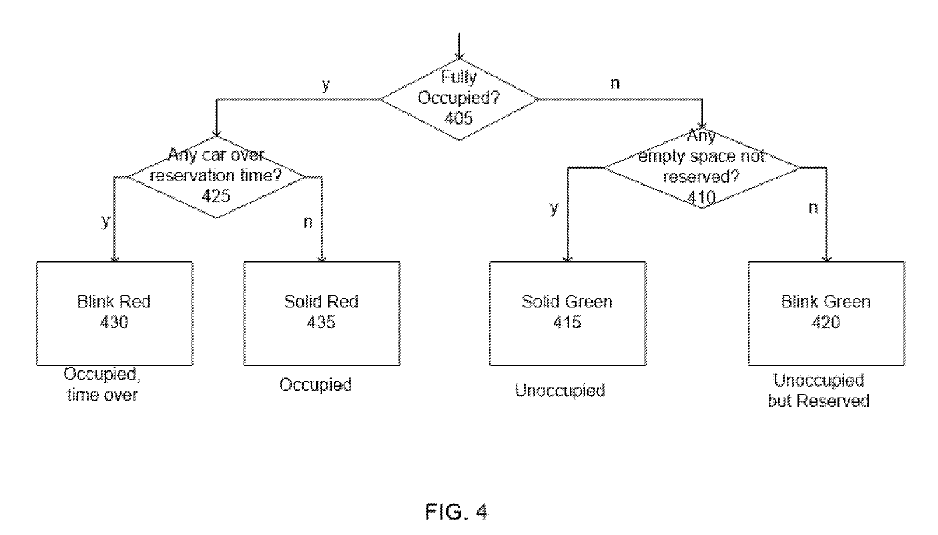

Referring to FIG. 4, illustrated is a flowchart for generating an occupancy indicator setting, according to an embodiment. In step 405, the occupancy indicator control module 316 determines if the spaces in the image are fully occupied from the occupancy information generated by the occupancy detection module 312. If no, in step 410 the occupancy indicator control module 316 determines if any empty space is not yet reserved. If there is at least one empty space that is not reserved, in step 415 the occupancy indicator setting is set such that the occupancy indicator light 154 emits a solid green light. However, if there is an empty space that is reserved, in step 420 the occupancy indicator setting is set such that the occupancy indicator light 154 emits a blinking green light.

In step 425, if the parking spaces are not fully occupied, the occupancy indicator control module 316 determines if any parked car has exceeded its reservation time using the reservation information and detected license plate. If yes, in step 430 the occupancy indicator setting is set such that the occupancy indicator light 154 emits a blinking red light. If no, in step 435 the occupancy indicator setting is set such that the occupancy indicator light 435 emits a solid red light.

Referring back to FIG. 3, in some embodiments, the occupancy indicator control module 316 may also generate the occupancy indicator setting depending on whether any motion is detected by the motion detection module 318. If no motion is detected for a pre-determined amount of time, the occupancy indicator setting may be set to turn off or reduce brightness of the occupancy indicator light 154. If motion is detected, the occupancy indicator setting may be set to turn on the occupancy indicator light 154. Thus further conserves energy when no vehicles or persons are in the parking garage.

The occupancy indicator setting is provided to the occupancy indicator interface 334, which uses the setting to generate one or more occupancy light control signals 335 for controlling the light output (e.g. color or pattern) by the occupancy indictor light 154. The light control signals 335 may be, for example, 0-12V signals, where different signals 335 control different colors of the indicator light 154. The occupancy indicator light 154 then emits light in accordance with the light control signals 335.

The motion detection module 318 processes the images captured by the camera 308 to detect motion in the parking garage. The motion detection module 318 may process the same images as those processed by the occupancy detection module 312. Alternatively, the motion detection module 318 and occupancy detection module 312 may process different set of images in the stream of images captured by the camera 308.

The motion detection module 318 applies a motion detection algorithm to detect motion in the images. In one embodiment, the motion detection module 318 can compare one image with the next image and count the number of changed pixels between the images. If the number of changed pixels exceeds a threshold, then the motion detection module 318 determines that motion has been detected. In another embodiment, the motion detection module 318 can use background subtraction to extract a foreground portion of an image (e.g. with humans and cars). An erosion-dilation filter is applied to the image, and then contours are located in the filtered image. Changes in the contours are then analyzed to detect motion. Additionally, the motion detection algorithm can be applied to the whole image so that motion is detected in both the aisle and several parking spaces, or just applied to a portion of the image that includes, for example, the aisle or the parking spaces.

The brightness control module 320 generates a brightness level setting for the light fixture 154 that is adjusted depending on whether motion is detected by the motion detection module 318. The brightness level setting controls the dimming level of the light fixture 152. If motion is detected, the brightness control module 320 increases the brightness setting to a maximum brightness level, thereby increasing light output by the light fixture 152. If motion is not detected, the brightness control module 320 decreases the brightness setting to a minimum brightness level, thereby decreasing light output by the light fixture 152. The minimum brightness level may completely shut off the light fixture, or may be a level that causes the light fixture to emit only a small amount of light.

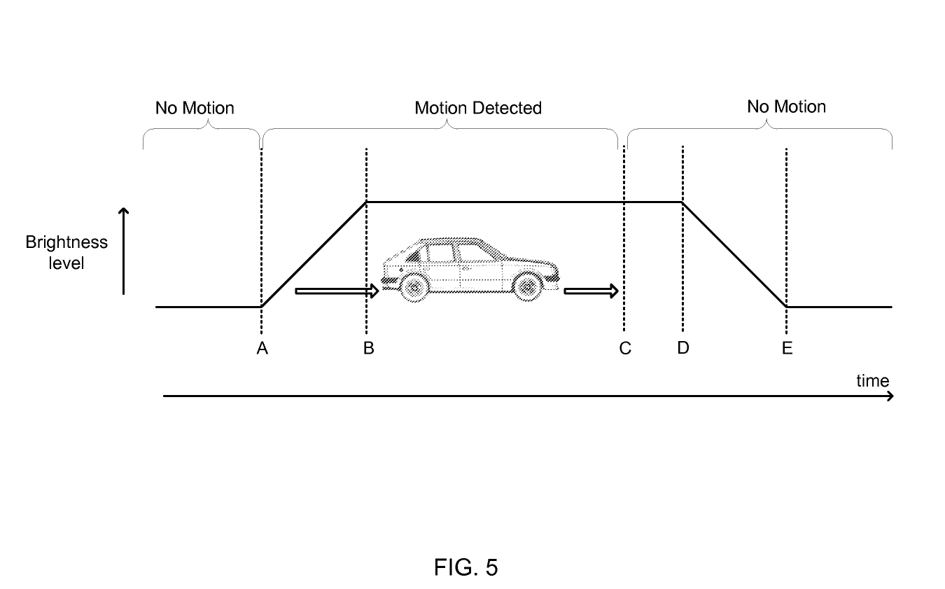

Referring briefly to FIG. 5, illustrated is a diagram of a dimming profile of the light fixture, according to an embodiment. Before time A, no motion is detected and the brightness setting is at the lowest level. At time A, motion is detected due to movement of a vehicle and the brightness setting is gradually increased in linear manner between time A and time B. Between time B and C, the brightness setting is maintained at its maximum level.

After time C, no more motion is detected. No motion is detected for a pre-determined amount of time between time C and D. Once a pre-determined amount of time has passed without motion detection, the brightness setting is gradually decreased in linear manner between time D and time E. After time E, because no more motion is detected, the brightness setting is maintained at its minimum level.

In some embodiments, the dimming profile may be such that the light fixture 154 is immediately switched on/off by the brightness setting. In some embodiments, the light fixture 154 is immediately turned on and gradually dimmed down. The immediate increase of brightness to quickly secure a clear view is for safe driving and safe walking. The gradual decrease of brightness is for minimizing a feeling of uneasiness which can result from abrupt darkness or blinking of lights as it is not safe to let a light immediately dim down ahead of a moving vehicle.

Referring to FIG. 3, the light fixture interface 332 generates one or more brightness control signals 333 from the brightness setting. For example, the brightness control signal 333 can be a 0-10 volt signal, where the voltage represents the brightness setting for the light fixture 152. The light fixture 152 controls the brightness of its emitted light in accordance with the brightness control signals 333, thereby allowing the light fixture 152 to be dimmed.

Dimmable light fixture 152 includes a LED driver 352 and one or more LEDs 356. The dimmable light fixture is powered from by an AC voltage from the AC power line 360. The LED driver 352 is a current regulator that regulates an amount of current through the LEDs under control of the brightness control signal 333. A higher brightness setting results in higher LED current, and therefore brighter light emitted by the LEDs 356. A lower brightness setting results in lower LED current, and therefore dimmer light emitted by the LEDs 356.

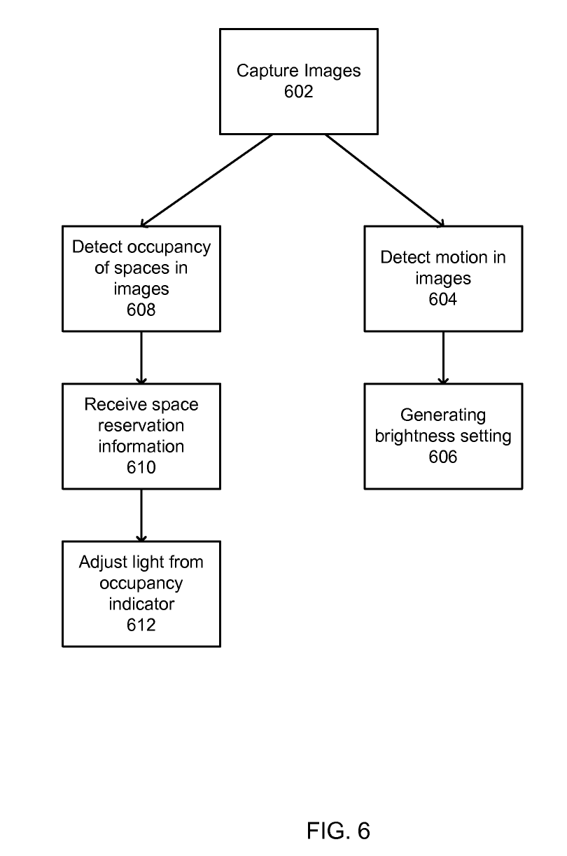

FIG. 6 is a flowchart for a method of smart parking performed in a vision sensor unit, according to an embodiment. In step 602, the camera 308 captures a series of images. In step 604, the motion detection module 318 processes the images to detect motion. In step 606, the brightness control module 320 generates a brightness setting for the light fixture responsive to whether motion is detected, thereby adjusting the brightness of the light fixture 152.

At or around the same time, in step 608 the occupancy detection module 312 processes the images to detect occupancy status of the parking spaces in the images. In step 610, the WiFi interface 304 receives reservation information indicating whether any of the parking spaces are reserved. Occupancy information about the occupancy of the parking spaces may also be wirelessly transmitted to the server 112. In step 612, the occupancy indicator control module 316 generates an occupancy indicator setting responsive to the occupancy status of the parking spaces and the reservation information.

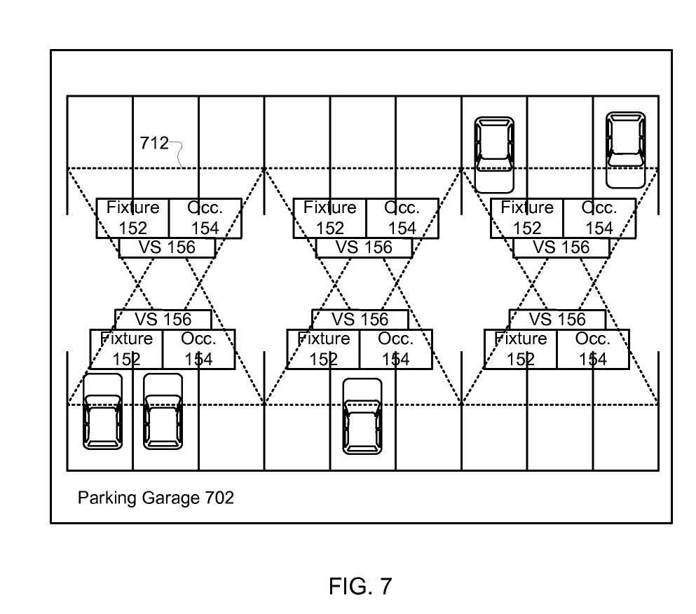

FIG. 7 is an overhead view of a parking garage 702 with vision sensor units, according to another embodiment. In FIG. 7, the light fixtures 152 are not located in the center of the aisle, but are located on the edges of the aisles near the rows of parking spaces. The vision sensor units 156 are coupled to the light fixtures 152 and are also located at the edges of the aisles.

In this configuration, each vision sensor 156 has a field of view 712 that covers the aisle and three parking spaces located on the opposite side of the aisle. Vision sensor units 156 on opposite sides of the aisle have an overlapping field of view 712. This configuration requires more vision sensors 156 than the embodiment of FIG. 1, but also provides a better view of the vehicle license plates.

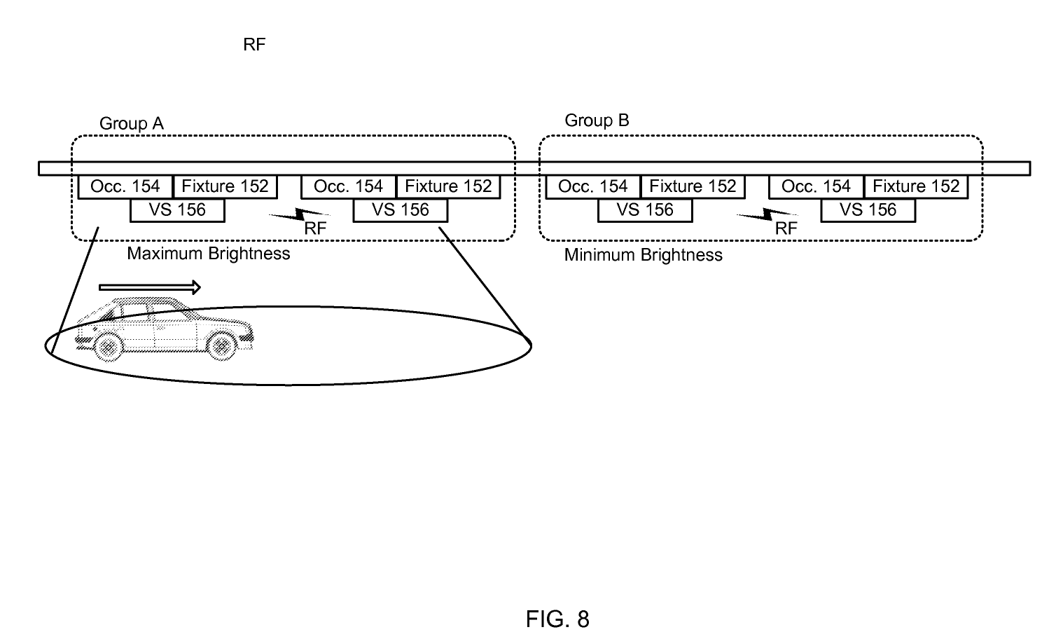

FIG. 8 is a side view of a parking garage with vision sensor units 156 divided into lighting groups, according to another embodiment. Two vision sensor units 156 and lighting fixtures 152 are assigned to lighting group A. Two vision sensor units 156 and lighting fixtures 152 are assigned to lighting group B. The light fixtures 152 of each lighting group are dimmed up or down in unison when motion is detected by any one of the vision sensors 156 in the group.

Here, motion is detected by a vision sensor unit 156 in group A, and therefore the lighting fixtures 152 in group A are all turned on to their maximum brightness. Motion has not yet been detected by any vision sensor units 156 in group B, and therefore the lighting fixtures 152 in group B are set to their minimum brightness.

To coordinate dimming between vision sensor units 156 in a group, the vision sensor units 156 in a group communicate with each other through wireless radio frequency (RF) signals. Referring back to FIG. 3, each vision sensor unit 156 can include a RF interface 306 that transmits wireless RF signals to the other vision sensor units 156 indicating whether motion has been detected. The RF interface 306 also receives RF signals from the other vision sensor units indicating whether motion has been detected by the other vision sensor units. The RF interface 306 operates in a RF spectrum between 3 kHz and 300 GHz.

Brightness control module 320 generates the brightness setting for the light fixture in accordance with whether motion has been detected by other vision sensor units assigned to the same lighting group as the vision sensor unit 156. The brightness control module 320 first determines if the RF signals are assigned to the same group as the vision sensor unit 156. If so, the brightness control module 320 gradually increases the brightness setting until it reaches the maximum brightness level. If not, the brightness control module 320 ignores the RF signals so that the brightness setting is not affected.

### Example Computer Architecture

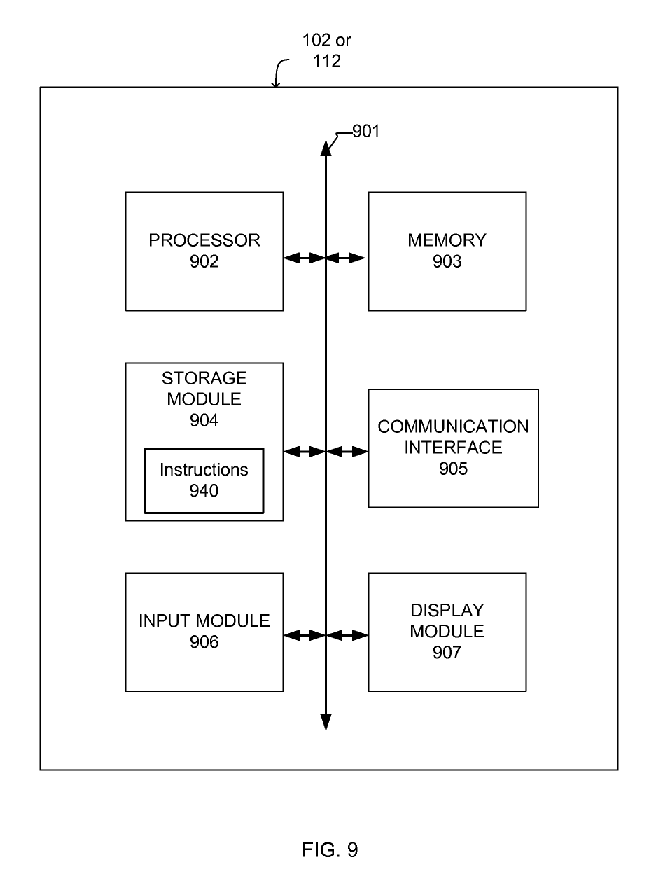

FIG. 9 illustrates the hardware architecture of a client device 102 or server 112, according to one embodiment. In one embodiment, the client device 102 or server 112 is a computer including components such as a processor 902, a memory 903, a storage module 904, an input module (e.g., keyboard, mouse, and the like) 906, a display module 907 and a communication interface 905, exchanging data and control signals with one another through a bus 901. The storage module 904 is implemented as one or more non-transitory computer readable storage media (e.g., hard disk drive), and stores software instructions 940 (e.g. modules) that are executed by the processor 902 in conjunction with the memory 903. Operating system software and other application software may also be stored in the storage module 904 to run on the processor 902.

Upon reading this disclosure, those of skill in the art will appreciate still additional alternative designs for a smart parking system. Thus, while particular embodiments and applications of the present disclosure have been illustrated and described, it is to be understood that the embodiments are not limited to the precise construction and components disclosed herein. The various modifications, changes and variations which will be apparent to those skilled in the art may be made in the arrangement, operation and details of the method and apparatus of the present disclosure disclosed herein without departing from the spirit and scope of the disclosure as defined in the appended claims.

1. A system comprising:
a plurality of occupancy indicator lights to emit light indicative of occupancy status of parking spaces;
a plurality of dimmable lighting fixtures; and
a plurality of vision sensing units, each vision sensing unit coupled to a dimmable lighting fixture and a respective occupancy indicator lights.

2. The system of claim 1, said vision sensing unit is further comprising:
a camera to capture images of a respective plurality of the parking spaces and a respective aisle of the parking garage;
a computer processor;
memory;
an occupancy detection module running on said computer processor to determine occupancy status of the respective plurality of parking spaces from the captured images;
a occupancy indicator control to generate an occupancy indicator setting for the light emitted by the respective occupancy indicator light based on the occupancy status;
and

3. The system of claim 2, wherein the occupancy indicator setting sets the occupancy indicator light to a first color light responsive to at least one of the respective plurality of parking spaces in the captured images being empty and the occupancy indicator setting sets the occupancy indicator light to second color light responsive to the plurality of parking spaces being filled.

4. The system of claim 2, wherein the vision sensing unit further comprises:
a motion detection module running on said computer processor to detect motion in said parking garage from the captured images.
a plurality of dimmable lighting fixtures for illuminating a parking garage having parking spaces and aisles;
a brightness control module to generate a brightness setting for a brightness of the respective dimmable lighting fixture based on the detected motion.

5. The system of claim 4, wherein the brightness setting is gradually increased when the motion detected, and the brightness setting is gradually decreased responsive to a lack of motion in the captured images over a pre-determined amount of time.

6. The system of claim 2, wherein the vision sensing unit further comprises:
a reservation module to receive reservation information about reservations of the parking spaces;
said occupancy indicator setting sets the occupancy indicator light to a first light pattern when the reservation information indicates the at least one of the parking spaces is reserved; and
said occupancy indicator setting sets the occupancy indicator light to a second light pattern when the at least one of the parking spaces in the captured images is reserved.

7. The system of claim 2, wherein each vision sensing unit further comprises:
a wireless interface circuit to wirelessly transmit occupancy information about the determined occupancy status of the plurality of parking spaces to a server system.

8. The system of claim 1, further comprising:
a server to receive occupancy information about the determined occupancy status of the plurality of parking spaces and provide parking services to client devices based on the determined occupancy status of the plurality of parking spaces.

9. The system of claim 4, wherein each vision sensing unit comprises:
a radio frequency interface circuit to receive radio frequency signals indicative of motion detected by other vision sensing units, the dimming level of said respective dimmable lighting fixture being further adjusted responsive to said radio frequency signals.

10. The system of claim 9, wherein the vision sensing units are divided into lighting zones, and the dimming level of the respective dimmable light fixture is adjusted responsive to a radio frequency signal if the radio frequency signal is from other vision sensing units in a same zone as the respective vision sensing unit but not adjusted if the radio frequency signal is from other vision sensing units in a different lighting zone as the respective vision sensing unit.

11. A vision sensing unit comprising of:
a camera to capture images of the plurality of the parking spaces and the aisle of the parking garage;
a computer processor;
memory;
an occupancy detection module running on said computer processor to determine occupancy status of the plurality of parking spaces from the captured images; and
a occupancy indicator control module to generate an occupancy indicator setting for the light emitted by the occupancy indicator light based on the occupancy status.

12. The system of claim 11 further comprising of:
a motion detection module running on said computer processor to detect motion in the parking garage from the captured images; and
a brightness control module to generate a brightness setting for a brightness of a dimmable lighting fixture based on the detected motion.

13. A method for operating a smart parking system on a computer processor comprising:
capturing images of the plurality of the parking spaces and the aisle of the parking garage with a camera;
determining occupancy status of the plurality of parking spaces by analyzing said images;
generating an occupancy indicator setting for the light emitted by the occupancy indicator light based on the occupancy status;
detecting motion from said images; and
generating a brightness setting for a brightness of the dimmable lighting fixture based on said detected motion.

14. The system of claim 1, wherein each vision sensing unit and said respective light fixture are located in the center of the aisle to manage plurality of parking spaces.

15. The system of claim 1, wherein each vision sensing unit and said respective light fixture are located on the edges of the aisle near rows of said parking spaces to manage plurality of parking spaces.
